(19) United States
(12) Patent Application Publication
(10) Pub. No.: US 2008/0264193 A1
(43) Pub. Date: Oct. 30, 2008

(54) Shifting Device for a Transmission of a Motor Vehicle and Shifting Method

(75) Inventors: Manfred Dorn, Stuttgart (DE); Ulrich Lasi, Herrenberg (DE); Joern Petersen, Stuttgart (DE); Gerhard Seidel, Denkendorf (DE); Stefan Sielaff, Muenchen (DE); Josef Stuempel, Borchen (DE)

Correspondence Address: CROWELL & MORING LLP;INTELLECTUAL PROPERTY GROUP, P.O. BOX 14300, WASHINGTON, DC, 20044-4300, US

(73) Assignee: Daimler AG, Stuttgart (DE)

(21) Appl. No.: 11/915,089

(22) PCT Filed: May 17, 2006
(86) PCT No.: PCT/EP2006/004677

§ 371 Date: May 21, 2008

(30) Foreign Application Priority Data
May 20, 2005 (US) 102005023969.2

(51) Int. Cl. B60K 20/00; F16H 3/38

(52) U.S. Cl. 74/473.3; 74/339

(57) ABSTRACT

A shift device for a transmission of a motor vehicle has a shift lever that can be moved into different shift positions, an actuating unit that, as a function of the shift position of the shift lever, generates a shift signal for transmitting to an electric transmission control unit, and an electric transmission control unit that, as a function of the shift signal of the actuating unit, sends an electric activation signal to a shift element of the transmission in order to set the desired shift stage. The actuating unit includes a restoring element or restoring elements operating in such a way that the shift lever, after reaching the selected shift position, is always moved automatically into a predefined starting position.

### BACKGROUND AND SUMMARY OF THE INVENTION

This invention relates to a shift device for a transmission of a motor vehicle having a shift lever which can be moved into different shift positions, having an actuating unit which, as a function of the shift position of the shift lever, generates a shift signal for transmitting to an electric transmission control unit, and having an electric transmission control unit which, as a function of the shift signal of the actuating unit, sends an electric activation signal to a shift element of the transmission in order to set the desired shift stage.

This invention also relates to a method for shifting a transmission of a motor vehicle, wherein as a function of the shift position of a shift lever, an electric activation signal is output to a shift element of the transmission in order to set the shift stage assigned to the shift position of the shift lever.

German document DE 197 46 438 A1 discloses a shift device for a transmission of a motor vehicle, in which, by means of a shift lever, a transmission is actuated in order to set a predefined shift stage. The shift lever is not mechanically connected to the transmission but rather acts electrically, by means of an actuating unit, on an electric transmission control unit which, as a function of a shift signal of the actuating unit, outputs an electric activation signal to a shift element of the transmission.

It is an object of the present invention to specify a shift device for a transmission of a motor vehicle and a shift method in such a way that the shift travels of the shift lever which are required for setting the shift stages are minimized in a user-friendly way.

To achieve this object, a shift device according to the invention has an actuating unit including restoring means operating in such a way that the shift lever, after reaching the selected shift position, is always moved automatically into a predefined starting position.

The particular advantage of the shift device according to the invention is that, as a result of the provided restoring means which move the shift lever back into a starting position after the shift lever is actuated, the shift travel required for setting the next shift stage can be considerably reduced. The user needs only in each case to move the shift lever from the starting position into the desired shift position. As a result of the shift lever always being moved into a preferably common starting position after said shift lever is actuated, the shift lever travel during the next setting of the shift stage can be kept low.

According to one preferred embodiment of the invention, the restoring means are formed by an actuating element which is resiliently mounted on the shift lever, and by a shift plate which is fixed in terms of movement and interacts with the actuating element. A plurality of switches which are assigned to the respective shift stages are arranged on the shift plate. These switches generate an electric shift signal when acted on by the actuating element, so that the electric transmission control unit is triggered so as to activate a shift element, which corresponds to the desired shift stage, of the transmission. The shift plate can be of substantially two-dimensional or three-dimensional design, with the position of the switches determining the length of the shift lever travel.

According to one refinement of the invention, the shift plate is formed as a shift channel with a plurality of inclined faces which, at least in cross section, taper in a narrowing fashion toward a base region. The inclined faces are aligned such that, in interaction with the actuating element, which presses against the inclined face by means of a preloaded spring, the actuating element is always moved automatically into the starting position. The switches, which are assigned to the inclined faces, for setting the corresponding shift stages can also be actuated by means of the preset pressing force with which the actuating element acts on the inclined faces or switches. The switches are preferably embodied as pressure switches.

According to another refinement of the invention, the inclined face of the actuating unit is provided with at least one step, so that the movement of the shift lever into the shift position takes place with the formation of a latching action. A clear and perceptible delimitation between the different shift positions of the shift lever is advantageously created in this way.

According to another refinement of the invention, the starting position of the shift lever is assigned to a base shift stage, with the actuating element being situated in a central region of the shift plate when the shift lever is in the starting position. It is advantageously hereby possible for a neutral shift stage to be reserved for the starting position of the shift lever.

According to yet another refinement of the invention, a visual display unit is assigned to the shift lever for signaling the selected shift stage. In this way, the operator can always check the presently set gear stage. It is not possible to identify the present shift stage from the position, which is always the same, of the shift lever in the starting position.

In a method according to the invention, the shift lever, during actuation of the latter, is always moved automatically into a starting position by restoring means.

The particular advantage of the method according to the invention is that the shift paths of the shift lever for setting the shift stages can be significantly reduced. The basic concept of the invention is to provide a decoupling between the position of the shift lever which represents a shift stage, and the shift stage. Regardless of the selected shift stage, the shift lever, after the actuation of the latter, is always situated in the preferred starting position. Corresponding restoring means of the actuating unit are provided for this purpose.

Further advantages of the invention are also claimed.

An exemplary embodiment of the invention is explained in more detail below with reference to the drawings.

### BRIEF DESCRIPTION OF THE DRAWINGS

FIG. 1 is a perspective illustration of an actuating unit,

FIG. 2 shows a plan view of a shift lever,

FIG. 3 shows a vertical section through the actuating unit along the line III-III of FIG. 2,

FIG. 4 shows a vertical section through the actuating unit along the line IV-IV of FIG. 3, and

FIG. 5 is an enlarged illustration of a detail X of the actuating unit in FIG. 4.

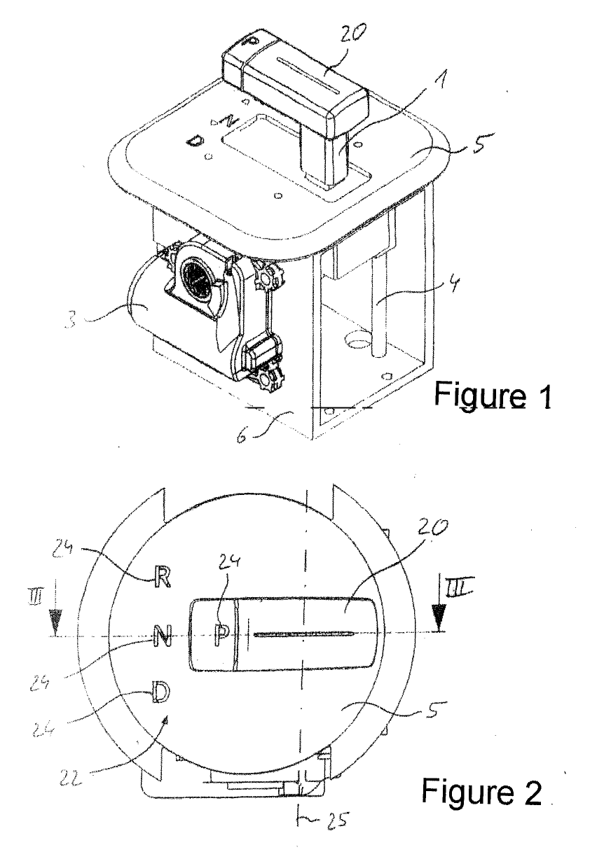

### DETAILED DESCRIPTION OF THE INVENTION

A shift device according to the invention for a transmission of a motor vehicle is composed substantially of a shift lever 1, an actuating unit 2 and an electric transmission control unit (not illustrated).

The shift lever 1 can be moved vertically by means of a drive unit 3 and a vertical guide 4 between a non-use position, in which the shift lever 1 extends with its upper side aligned flush with an upper side 5 of a housing 6, and a use position, in which the shift lever 1 is arranged, as per the figures, so as to be extended out of the recess of the housing 6. In the use position, the shift lever 1 serves to set a desired shift stage of the transmission, which is embodied as an automatic transmission. For this purpose, the shift lever 1 is mounted so as to be pivotable about a horizontal pivot axis 7 of a base part 8 of the shift lever 1.

The base part 8 comprises a shift plate 9 which extends in a horizontal plane. A cutout is provided on the shift plate 9 in a central region 10 (base region), into which cutout a first switch 11 engages from below. The shift plate 9 is embodied as a shift channel having two opposing inclined faces 12 which run in a tapering fashion in the direction of the base region 10. The inclined faces 12 form an acute angle α (for example 25°) with respect to a horizontal plane. The inclined faces 12 serve as sliding or guide faces for an actuating element 13, which is arranged by means of a preloaded spring 14 in a recess of an actuating web 15 of the shift lever 1. The actuating element 13, which can be embodied as a roller, is pressed constantly by means of the spring 14 against the inclined faces 12 or the first switch 11—as a function of the position of the actuating element 13.

The first switch 11 is situated directly adjacent to an inner edge 16 of the inclined faces 12. An outer edge 17 of the inclined faces 12 is adjoined at opposite sides in each case by a second switch 18 and a third switch 19. The second and third switches 18, 19 are aligned perpendicular to the first switch 11 and are arranged so as to be raised above the shift plate 9. In this way, the shift travel between the central position of the actuating element 13 and an outer shift position with loading of the second switch 18 or of the third switch 19 can be further shortened.

The first switch 11, the second switch 18 and the third switch 19 are embodied as pressure switches, preferably as microswitches. When the first switch 11 is loaded by the actuating element 13, a shift signal is transmitted to the electric transmission control unit, which shift signal triggers the transmission control unit to output an electric activation signal to a shift element of the transmission in order to set a shift stage neutral (N). The shift stage N serves as a base shift stage. When the second switch 18 is acted on by the actuating element 13, a shift signal is passed to the electric transmission control unit such that a shift stage D for forward travel is set. When the third switch 19 is acted on by the actuating element 13, a shift signal is generated which triggers the transmission control unit to trigger the shift element of the transmission to set the shift stage for reverse travel (R). A further actuating element 21 is arranged in a shift knob 20 of the shift lever 1; when this further actuating element 21 is acted on, a shift signal is generated which triggers the electric transmission control unit to set a shift element of the transmission to set the shift stage for parking (P).

A visual display unit 22 is provided to display the correspondingly set shift stages. For this purpose, light-emitting diodes are integrated into the base part 8 and the shift knob 20, which light-emitting diodes indicate the present shift stage by means of a highlighted or different-colored symbol 24.

The actuating unit 2 is formed substantially by the actuating element 13, the shift plate 9 and the switches 11, 18, 19.

According to an embodiment of the invention which is not illustrated, the shift plate 9 can also comprise a plurality of switches which are not situated—as discussed above—in a plane in a vertical section, but rather are arranged along a circumferential line around the base region 10. In this case, the shift plate 9 has spherical or spherical-cap-shaped inclined faces. In addition, this embodiment results in the shift lever 1 being, for example, cardanically mounted, such that it can be pivoted in more than two directions.

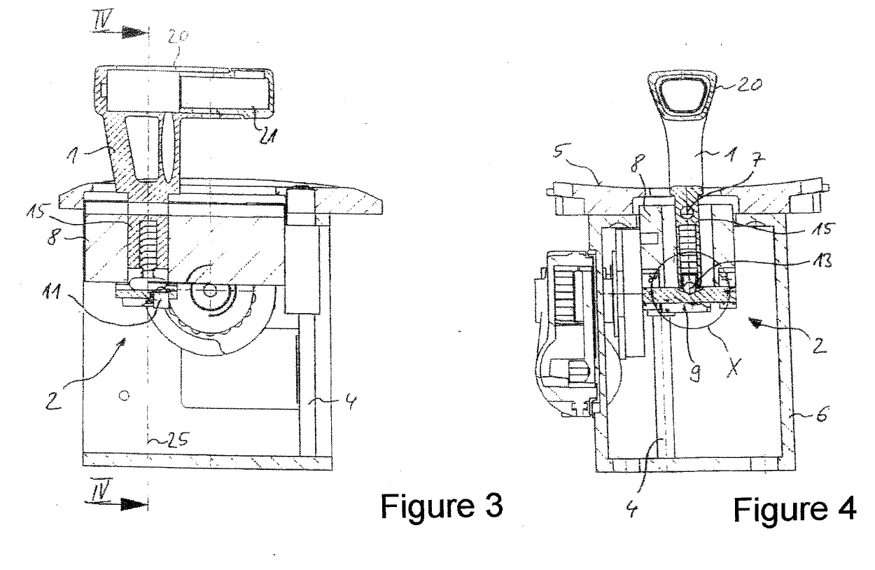

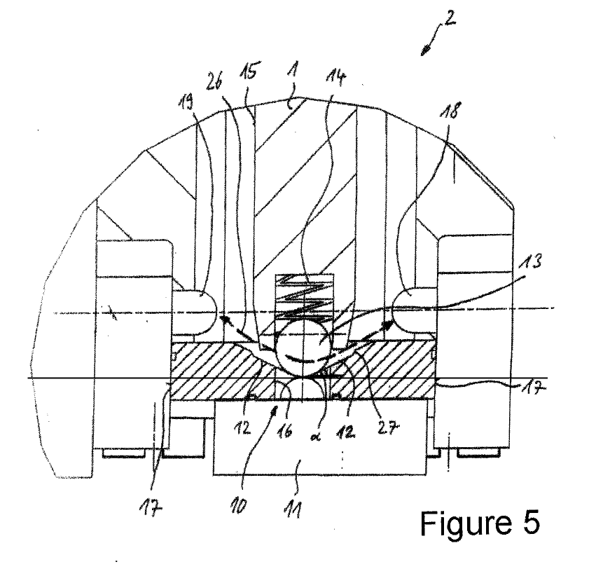

FIGS. 3, 4 and 5 illustrate the shift lever 1 in a central starting position in which the actuating element 13 presses against the first switch 11. It should be assumed that the shift stage D is set. In this case, the symbol D would for example be lit up in red, while the other symbols R, N, P are lit up in white. In order to set the transmission into the shift stage reverse (R), the shift lever 1 is moved in a shift lever plane 25 in such a way that the actuating element 13, while sliding on the inclined face 12, is moved along a movement path 26 until it acts on the third switch 19. As a result of the third switch 19 being actuated, the shift stage of the transmission changes from forward (D) to reverse (R). This is correspondingly signaled by a change of the color of the symbol R from white to red. When the shift lever 1 is released, the actuating element 13 or actuating web 15 and the shift lever 1 is moved back into the central starting position as a result of the inclined face 12, as is illustrated by way of example in FIG. 4.

The inclined faces 12 each have steps 27 which extend transversely with respect to the movement path 26. In this way, a latching movement of the actuating element 13 is generated, which signals to the operator in a perceptible and audible way that the desired shift stage has been actuated. The transmission control unit is configured such that no change in the shift stage is generated by an actuation of the first switch 11 directly after an actuation of the second or third switch 18, 19.

To set the shift stage neutral (N), it is sufficient for the actuating web 15 to move out of the central starting position, in which the actuating element 13 presses against the central switch 11, to the step 27 of the inclined face 12, so that the first switch 11 is unloaded and a loading takes place by means of the automatic return movement of the actuating element 13 into the starting position. The shift lever travel to set the shift stage neutral (N) is therefore approximately half as long as the shift lever travel for setting the shift stages forward (D) and reverse (N).

Serving as restoring means for automatically moving the actuating element 13 into the central starting position are both the shift plate 9, which is provided with inclined faces 12, and the resiliently mounted actuating element 13, which always presses with a predefined pressing force against the switches 11, 18, 19 or the inclined faces 12.

1-12. (canceled)

13. A shift device for a transmission of a motor vehicle comprising:
a shift lever that can be moved into different shift positions,
an actuating unit that, as a function of a shift position of the shift lever, generates a shift signal, and
an electric transmission control unit that receives the shift signal and which, as a function of the shift signal, sends an electric activation signal to a shift element of the transmission in order to set the desired shift stage,
wherein the actuating unit comprises restoring means operating in such a way that the shift lever, after reaching the selected shift position, is always moved automatically into a predefined starting position.

14. The shift device as claimed in claim 13, wherein the restoring means are formed by a shift plate that is fixed in terms of movement and has a number of switches assigned to the shift stages and arranged in a distributed fashion as well as by a resiliently mounted actuating element of the shift lever, and wherein the shift lever is mounted so as to be pivotable about a pivot axis that is spaced apart from the shift plate.

15. The shift device as claimed in claim 14, wherein the shift plate is formed as a shift channel with opposing inclined faces that taper in a narrowing fashion in a base region, and wherein the switches are arranged in each case in a region of an outer edge of at least one of an inclined face and an inner edge of that inclined face.

16. The shift device as claimed in claim 14, wherein the switches are arranged along a movement path of the actuating element, and wherein the movement path runs substantially perpendicular to the pivot axis.

17. The shift device as claimed in claim 15, wherein the inclined face runs at an acute angle with respect to a horizontal plane.

18. The shift device as claimed in claim 14, wherein the actuating element is mounted by way of a preloaded spring in a recess of an actuating web of the shift lever, and wherein the spring exerts a shift force, which triggers the switch, on the actuating element.

19. The shift device as claimed in claim 15, wherein the inclined face is provided with at least one step in such a way that the actuating element is moved into the desired shift position with a latching action.

20. The shift device as claimed in claim 14, wherein a starting position of the shift lever is assigned a base shift stage, and wherein the actuating element is situated in a central region of the shift plate when the shift lever is in the starting position.

21. The shift device as claimed in claim 13, wherein a visual display unit is provided for signaling the selected shift stage.

22. The shift device as claimed in claim 15, wherein the switches are arranged along a movement path of the actuating element, and wherein the movement path runs substantially perpendicular to the pivot axis.

23. The shift device as claimed in claim 22, wherein the inclined face runs at an acute angle with respect to a horizontal plane.

24. The shift device as claimed in claim 16, wherein the actuating element is mounted by way of a preloaded spring in a recess of an actuating web of the shift lever, and wherein the spring exerts a shift force, which triggers the switch, on the actuating element.

25. The shift device as claimed in claim 17, wherein the inclined face is provided with at least one step in such a way that the actuating element is moved into the desired shift position with a latching action.

26. The shift device as claimed in claim 15, wherein a starting position of the shift lever is assigned a base shift stage, and wherein the actuating element is situated in a central region of the shift plate when the shift lever is in the starting position.

27. The shift device as claimed in claim 18, wherein a starting position of the shift lever is assigned a base shift stage, and wherein the actuating element is situated in a central region of the shift plate when the shift lever is in the starting position.

28. The shift device as claimed in claim 14, wherein a visual display unit is provided for signaling the selected shift stage.

29. The shift device as claimed in claim 15, wherein a visual display unit is provided for signaling the selected shift stage.

30. A method for shifting a transmission of a motor vehicle, comprising:
outputting, as a function of the shift position of a shift lever, an electric activation signal to a shift element of the transmission in order to set the shift stage assigned to the shift position of the shift lever, and
always moving the shift lever, during the actuation of the latter, automatically into a starting position by way of at least one restoring element.

31. The method as claimed in claim 30, wherein the shift lever is always moved automatically into the same starting position.

32. The method as claimed in claim 30, wherein the desired shift stage is set as a function of the length of the shift lever travel in at least one predefined direction.
